(19) United States
(12) Patent Application Publication
(10) Pub. No.: US 2026/0267184 A1
(43) Pub. Date: Sep. 10, 2026

(54) BACKPLANE AND DISPLAY SCREEN

(71) Applicant: SHENZHEN HITEVISION TECHNOLOGY CO., LTD., Shenzhen, Guangdong (CN)

(72) Inventors: Xulai HE, Shenzhen, Guangdong (CN); Chun WANG, Shenzhen, Guangdong (CN); Xin ZHOU, Shenzhen, Guangdong (CN)

(73) Assignee: SHENZHEN HITEVISION TECHNOLOGY CO., LTD., Shenzhen, Guangdong (CN)

(21) Appl. No.: 19/489,260

(22) PCT Filed: Apr. 8, 2024
(86) PCT No.: PCT/CN2024/086562

§ 371 Date: Dec. 1, 2025

(30) Foreign Application Priority Data
Jul. 25, 2023 (CN) 202321984197.8

(51) Int. Cl. G02F 1/1333

(52) U.S. Cl. CPC G02F 1/133314

(57) ABSTRACT

A backplane and a display screen are provided. The backplane comprises a backplane body, a connection section, and a support section which are successively connected. The backplane body is disposed on the side of an optical component away from a tempered glass, and a bearing surface is provided on the side of the backplane body close to the optical component, the bearing surface being used for supporting the optical component and a liquid crystal glass. The support section is used for supporting the tempered glass. The backplane supports the optical component and the liquid crystal glass by means of the bearing surface of the backplane body, and supports the tempered glass by means of the support portion to eliminate the structures of a front frame, a middle frame and a tempered glass beading strip in an existing display screen, and allow the display screen to have a simpler structure.

### CROSS-REFERENCE TO RELATED APPLICATIONS

This application claims priority to Chinese patent application No. 202321984197.8, entitled “BACKPLANE AND DISPLAY SCREEN”, filed on Jul. 25, 2023, the entire contents of which are incorporated herein by reference.

### TECHNICAL FIELD

The present application relates to the technical field of human-computer interaction devices, and particularly, to a backplane and a display screen.

### BACKGROUND

In order to provide convenience for people's life, there is a display screen with the function of human-computer interaction on the market. The display screen consists of a frame, a backplane, a front frame, a middle frame, a tempered glass bead, tempered glass, liquid crystal glass, and an optical component. The tempered glass is clamped between the tempered glass bead and an infrared filter strip of the frame, the front frame is installed in the middle frame, the middle frame is installed on the backplane by a positioning column, the liquid crystal glass is placed in a gap between the front frame and the middle frame, and the optical component is placed on the backplane. At present, since the display screen has complex structure and numerous parts, the assembly process is cumbersome, the assembly difficulty is severe, and the assembly efficiency is low.

### SUMMARY

An object of embodiments of the present application is to provide a backplane and a display screen to solve the problems that the assembly process is cumbersome, the assembly difficulty is severe, and the assembly efficiency is low in the related art caused by the complex structure and the numerous parts of the display screen.

In order to achieve the above object, in an aspect of the present application, there is provided a backplane applicable to a display screen that includes tempered glass, liquid crystal glass, and an optical component, where the liquid crystal glass and the optical component are stacked, the tempered glass is disposed at a side of the liquid crystal glass away from the optical component; the backplane includes a backplane body, a connection section, and a support section connected in sequence.

The backplane body is disposed on a side of the optical component away from the tempered glass, and a bearing surface is provided on a side of the backplane body close to the optical component; the connection section is disposed on a side of the backplane body close to the tempered glass, the connection section and the backplane body form an accommodation cavity, the liquid crystal glass and the optical component are both disposed in the accommodation cavity, and the bearing surface is configured to support the optical component and the liquid crystal glass; and the support section is configured to support the tempered glass.

Optionally, a limiting surface perpendicular to the bearing surface is provided on a side of the connection section close to the backplane body has; and the limiting surface abuts against the liquid crystal glass to prevent the liquid crystal glass from sliding out of the accommodation cavity along the limiting surface.

Optionally, the connection section includes a first segment and a second segment connected in sequence, the backplane body is connected to a side of the first segment away from the second segment, the support section is connected to a side of the second segment away from the first segment, and the limiting surface is disposed on a side of the first segment close to the accommodation cavity; the second segment inclines from a side close to the first segment to a side close to the support section along a direction away from the accommodation cavity.

Optionally, a positioning column is provided on the bearing surface and is inserted through a positioning hole in the optical component.

Optionally, the backplane further includes an installation section that is disposed at a side of the support section away from the connection section and is configured to be connected to a frame of the display screen.

Optionally, a positioning plate is provided on a side of the installation section away from the support section and is configured to be inserted into a positioning groove of the frame of the display screen.

In another aspect of the present application, a display screen is further provided, and the display screen includes: a frame, and tempered glass, liquid crystal glass, and an optical component that are disposed in the frame, where the liquid crystal glass and the optical component are stacked, and the tempered glass is disposed at a side of the liquid crystal glass away from the optical component; and the backplane, where the backplane is disposed on a side of the optical component away from the tempered glass and is connected to the frame, the optical component is disposed on the bearing surface, and the tempered glass abutting against the support section.

Optionally, an adhesive part is provided on a side of the liquid crystal glass close to the optical component along a circumferential direction of the liquid crystal glass, and the liquid crystal glass is bonded to the optical component by the adhesive part.

Optionally, a limiting block is provided on the backplane, and two adjacent sides of the limiting block abut against the bearing surface and the connection section, respectively; and the limiting block abuts against the liquid crystal glass to prevent the liquid crystal glass from sliding out.

Optionally, the frame is provided with a clamping section located at a side of the support section, and two opposite sides of the tempered glass abut against the clamping section and the support section, respectively.

The backplane and the display screen according to the present application have the following beneficial effects: the backplane includes the backplane body, the connection section, and the support section connected in sequence; the backplane body is disposed on a side of the optical component away from the tempered glass, the bearing surface for supporting the optical component and the liquid crystal glass is disposed on a side of the backplane body close to the optical component, and the support section is for supporting the tempered glass. The backplane in the present application supports the optical component and the liquid crystal glass by the bearing surface of the backplane body while supporting the tempered glass by the support section, so that the front frame, the middle frame and the tempered glass bead in the existing display screen can be saved, and the structure of the interactive display screen is simplified, thereby reducing the difficulty of assembling the interactive display screen and increasing the efficiency of assembling the interactive display screen.

### BRIEF DESCRIPTION OF THE DRAWINGS

In order to illustrate the technical solutions in the embodiments of the present application more clearly, the drawings to be used in the description of the embodiments or the related art will be briefly introduced below. It is obvious that the drawings described below are only some embodiments of the present application, and for those of ordinary skill in the art, other drawings can be obtained based on these drawings without inventive effort.

FIG. 1 is a partial cross-sectional view of a display screen in the prior art of the present application;

FIG. 2 is an exploded view of the overall structure of a display screen (the frame is removed) according to the present application;

FIG. 3 is a schematic view of the overall structure of a backplane according to the present application;

FIG. 4 is an enlarged view of FIG. 3 at X;

FIG. 5 is a partial cross-sectional view of a backplane according to the present application;

FIG. 6 is a partial cross-sectional view of a display screen along a central axis of a positioning column according to the present application; and

FIG. 7 is a partial cross-sectional view of a display screen along an axis of a limiting block according to the present application.

### REFERENCE SIGNS

1: Backplane; 11: Backplane body; 111: Bearing surface; 112: Positioning column;
12: Connection section; 121: First segment; 1211: Limiting surface; 122: Second segment; 13: Support section; 14: Installation section; 141: Positioning plate; 15: Bent section; 16: Limiting block;
2: Display screen; 21: Frame; 211: Positioning groove; 212: Infrared touch pad; 213: Infrared filter strip; 214: Clamping section; 22: Front frame; 23: Middle frame; 24: Tempered glass bead; 25: Tempered glass; 26: Liquid crystal glass; 27: Optical component; 271: Reflective sheet; 272: Diffusion plate; 273: Optical film.

### DETAILED DESCRIPTION

In order to make the technical problems, technical solutions, and beneficial effects of the present application clearer, the present application will be further described in detail below with reference to the drawings and embodiments. It should be understood that the specific embodiments are described herein only for illustrating the present application instead of limiting the present application.

It should be noted that when an element is “fixed to” or “disposed on” another element, it may be directly or indirectly on another element. When an element is “connected to” another element, it may be directly or indirectly connected to another element.

It should be understood that the orientations or positional relationships indicated by the terms such as “length”, “width”, “upper”, “lower”, “front”, “back”, “left”, “right”, “vertical”, “horizontal”, “top”, “bottom”, “inner”, “outer” are based on the orientations or positional relationships shown in the drawings, and are only for facilitating and simplifying the description of the present application but not for indicating or implying that the referenced apparatuses or elements must have a particular orientation, or be configured and operated in a particular orientation, which cannot be understood as the limitation to the present application.

Further, the terms “first” and “second” are for descriptive purposes only and cannot be understood as indicating or implying relative importance or implicitly indicating the number of technical features indicated. Thus, a feature defined with “first” or “second” may explicitly or implicitly include one or more of the feature. In the description of the present application, “a plurality of” means two or more, unless otherwise explicitly and specifically defined.

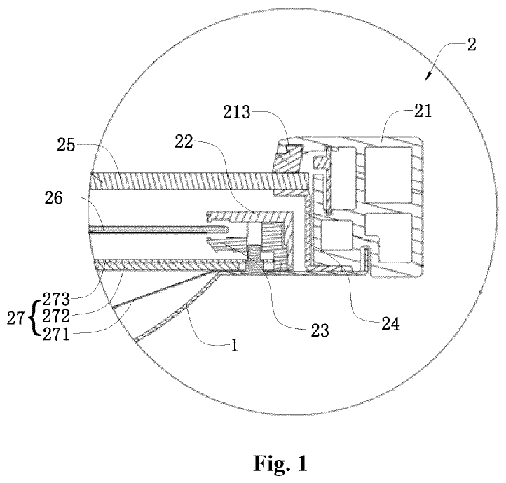

As recited in the BACKGROUND, as shown in FIG. 1, a display screen 2 consists of a frame 21, a backplane 1, a front frame 22, a middle frame 23, a tempered glass bead 24, a tempered glass 25, a liquid crystal glass 26, and an optical component 27. The tempered glass 25 is clamped between the tempered glass bead 24 and the infrared filter strip 213 of the frame 21, and the liquid crystal glass 26 and the optical component 27 are installed on the backplane 1 through the front frame 22 and the middle frame 23. When the display screen 2 is assembled, the tempered glass bead 24 needs to be installed on the frame 21 to fix the position of the tempered glass 25, and the front frame 22 and the middle frame 23 need to be installed on the backplane 1 to fix the position of the liquid crystal glass 26. When the display screen 2 is assembled, many parts need to be installed, the assembly process is cumbersome, the assembly difficulty is severe, and the assembly efficiency is low.

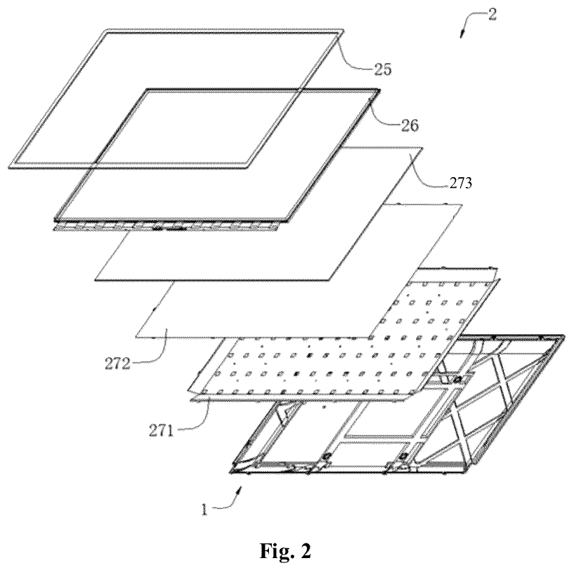

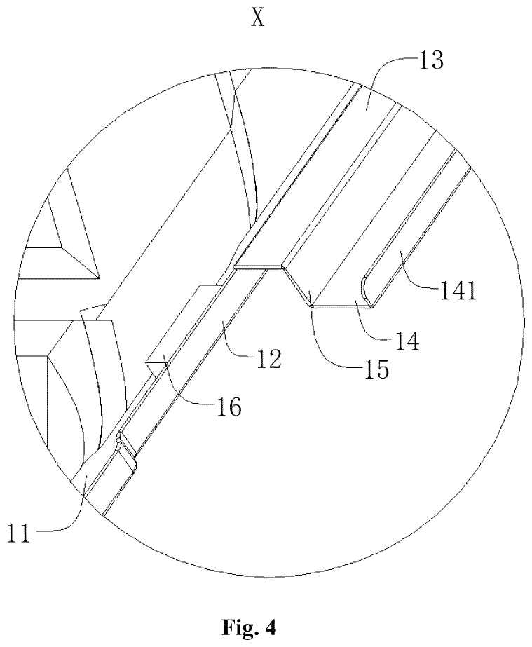

In order to solve the above problems, in an aspect of the present application, as shown in FIG. 2 to FIG. 7, the present application provides the backplane 1 applicable to the display screen 2, the display screen 2 includes the tempered glass 25, the liquid crystal glass 26, and the optical component 27, the liquid crystal glass 26 and the optical component 27 are stacked, the tempered glass 25 is disposed at a side of the liquid crystal glass 26 away from the optical component 27, and the backplane 1 includes the backplane body 11, the connection section 12, and the support section 13 connected in sequence; the backplane body 11 is disposed on a side of the optical component 27 away from the tempered glass 25, the bearing surface 111 is disposed on a side of the backplane body 11 close to the optical component 27, the connection section 12 is disposed on a side of the backplane body 11 close to the tempered glass 25, the connection section 12 and the backplane body 11 form the accommodation cavity, the liquid crystal glass 26 and the optical component 27 are both placed in the accommodation cavity, and the bearing surface 111 is configured to support the optical component 27 and the liquid crystal glass 26; and the support section 13 is configured to support the tempered glass

Specifically, the backplane 1 supports the optical component 27 and the liquid crystal glass 26 by the bearing surface 111 of the backplane body 11 while supporting the tempered glass 25 by the support section 13, so that the front frame 22, the middle frame 23 and the tempered glass bead 24 in the existing display screen 2 can be saved, and the structure of the display screen 2 is simplified, thereby reducing the difficulty of assembling the display screen 2 and increasing the efficiency of assembling the display screen 2.

In addition, the liquid crystal glass 26 and the optical component 27 are both disposed in the accommodation cavity formed by the backplane body 11 and the connection section 12, and the connection section 12 abuts against the side of the liquid crystal glass 26 to prevent the liquid crystal glass 26 from sliding out of the optical film 273 of the optical component 27 and prevent the optical film 273 from being damaged by pulling.

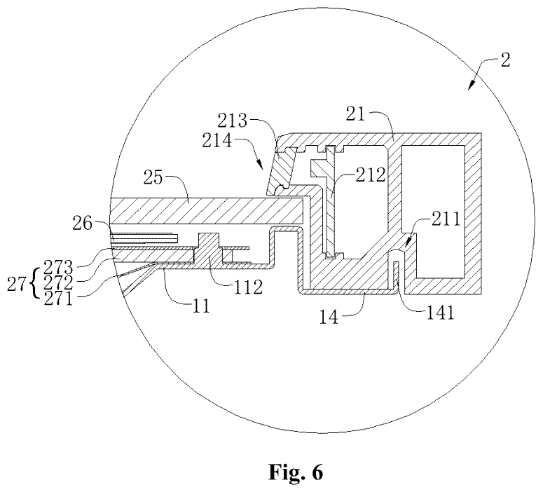

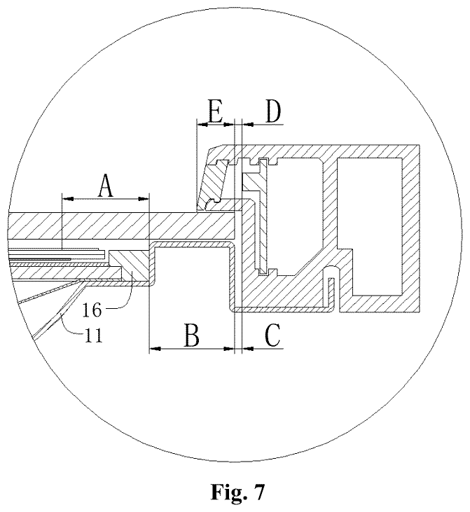

It should be noted that, in this embodiment, as shown in FIG. 6 and FIG. 7, the optical component 27 includes the reflective sheet 271, the diffusion plate 272, and the optical film 273 stacked in sequence along the direction from the backplane body 11 to the liquid crystal glass 26. Specifically, the reflective sheet 271 is disposed on the bearing surface 111 of the backplane body 11, and the liquid crystal glass 26 is attached to the optical film 273.

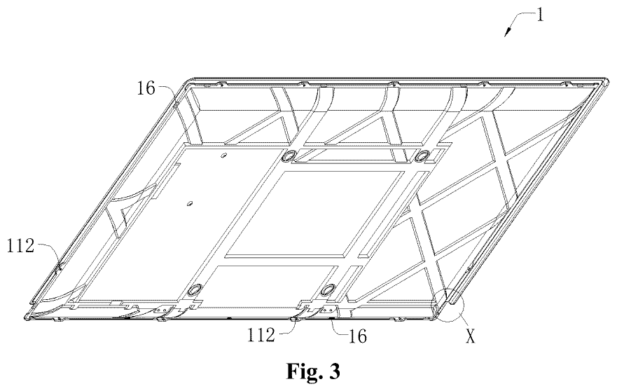

In an embodiment, as shown in FIG. 3 to FIG. 5, the limiting surface 1211 perpendicular to the bearing surface 111 is provided on a side of the connection section 12 close to the backplane body 11; and the limiting surface 1211 abuts against the liquid crystal glass 26 to prevent the liquid crystal glass 26 from sliding out of the accommodation cavity along the limiting surface 1211.

Specifically, under a condition that the liquid crystal glass 26 slides relative to the optical film 273, the limiting surface 1211 disposed on the side of the connection section 12 close to the backplane body 11 and perpendicular to the bearing surface 111 abuts against the liquid crystal glass 26 to prevent the liquid crystal glass 26 from sliding out of the optical film 273 along the limiting surface 1211 and prevent the optical film 273 from being damaged by pulling. It should be noted that under a condition that the included angle between the limiting surface 1211 and the bearing surface 111 is an obtuse angle, and the liquid crystal glass 26 slides relative to the optical film 273 of the optical component 27, the liquid crystal glass 26 can slide out of the optical film 273 along the inclined limiting surface 1211, thereby pulling the optical film 273, whereas the limiting surface 1211 is perpendicular to the bearing surface 111, which may prevent the liquid crystal glass 26 from sliding out of the optical film 273 along the limiting surface 1211.

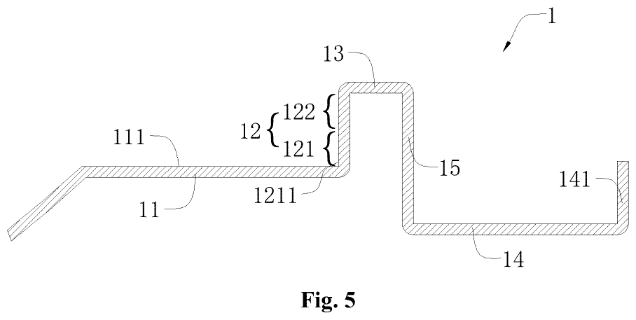

In a specific embodiment, as shown in FIG. 5, the connection section 12 includes the first segment 121 and the second segment 122 connected in sequence, the backplane body 11 is connected to a side of the first segment 121 away from the second segment 122, the support section 13 is connected to a side of the second segment 122 away from the first segment 121, and the limiting surface 1211 is disposed on a side of the first segment 121 close to the accommodation cavity; and the second segment 122 inclines from a side close to the first segment 121 to a side close to the support section 13 along the direction away from the accommodation cavity.

Specifically, for the tempered glass 25, after the distance of the connection section 12 along the direction from the optical component 27 to the tempered glass 25 is greater than the preset size, the second segment 122 of the connection section 12 inclines from a side close to the first segment 121 to a side close to the support section 13 along the direction away from the accommodation cavity, that is, the included angle between the second segment 122 and the first segment 121 of the connection section 12 and the included angle between the second segment 122 of the connection section 12 and the support section 13 are both obtuse angles, so that a trapezoidal structure is formed at the supporting position of the tempered glass 25 to ensure that the support section 13 has enough supporting force to support the tempered glass 25. For example, for a tempered glass 25 with the thickness of 0.6 mm, after the distance of the connection section 12 along the direction from the optical component 27 to the tempered glass 25 is greater than 2 mm, the second segment 122 of the connection section 12 needs to incline from a side close to the first segment 121 to a side close to the support section 13 along the direction away from the accommodation cavity to ensure that the support section 13 has enough supporting force to support the tempered glass 25.

In an embodiment, as shown in FIG. 6, the positioning column 112 is disposed on the bearing surface 111 and is inserted through the positioning hole in the optical component 27.

Specifically, the positioning hole is disposed on the hanging ear of the optical film 273 of the optical component 27, and when installed, the positioning column 112 is inserted through the positioning hole of the optical film 273, so that the optical film 273 can be fixed to prevent the position of the optical film 273 from being shifted.

In an embodiment, as shown in FIG. 5 to FIG. 7, the backplane 1 further includes the installation section 14, the installation section 14 is disposed at a side of the support section 13 away from the connection section 12, and the installation section 14 is connected to the frame 21 of the display screen 2.

Specifically, the backplane 1 is fixedly connected to the frame 21 of the display screen 2 by the installation section 14, and the installation section 14 may be screwed onto the frame 21 of the display screen 2.

In a specific embodiment, the positioning plate 141 is disposed on a side of the installation section 14 away from the support section 13, and the positioning plate 141 is inserted into the positioning groove 211 of the frame 21 of the display screen 2.

The positioning plate 141 is disposed on a side of the installation section 14 away from the support section 13, and the positioning plate 141 can be disposed in the positioning groove 211 of the frame 21 of the display screen 2 to position the installing of the backplane 1 and ensure the accuracy of the installation position of the backplane 1.

In this embodiment, as shown in FIG. 5 to FIG. 7, the bent section 15 is disposed between the support section 13 of the backplane 1 and the installation section 14 of the backplane 1; the bent section 15 is disposed on a side of the support section 13 away from the accommodation cavity and extends along the direction away from the tempered glass 25. It should be noted that the display screen 2 in this embodiment has the function of human-computer interaction, that is, the infrared touch pad 212 and the infrared filter strip 213 are disposed in the frame 21 of the display screen 2, and the infrared filter strip 213 is disposed on a side of the tempered glass 25 away from the backplane 1; the infrared touch pad 212 is installed in the cavity of the frame 21, is located at a side of the infrared filter strip 213, and is configured to emit infrared light that can pass through the infrared filter strip 213, so as to obtain the position information of the finger of a person when the finger touches the display screen 2.

Specifically, the infrared touch pad 212 is installed in the cavity of the frame 21, so that the distance of the frame 21 along the direction from the optical component 27 to the tempered glass 25 is increased, and the bent section 15 is disposed, so that the backplane 1 may be adapted to the frame 21 having the structure changed due to the installing of the infrared touch pad 212, so as to prevent the interference between the backplane 1 and the frame 21 when the display screen 2 is assembled; for the display screen 2 that does not have the function of human-computer interaction, the frame 21 of the display screen 2 does not need to be provided with the infrared touch pad 212 and the infrared filter strip 213, the distance of the frame 21 along the direction from the optical component 27 to the tempered glass 25 is not increased, and therefore the bent section 15 is not required.

In another aspect of the present application, as shown in FIG. 6 and FIG. 7, embodiments of the present application provide the display screen 2, the display screen 2 includes the frame 21, the backplane 1 in any one of the above embodiments, and the tempered glass 25, the liquid crystal glass 26, and the optical component 27 all disposed in the frame 21, the liquid crystal glass 26 and the optical component 27 are stacked, and the tempered glass 25 is disposed at a side of the liquid crystal glass 26 away from the optical component 27; the backplane 1 is disposed on a side of the optical component 27 away from the tempered glass 25 and is connected to the frame 21; the optical component 27 is disposed on the bearing surface 111, and the tempered glass 25 abuts against the support section 13.

It may be understood that, since the display screen 2 includes the backplane 1, the optical component 27, the liquid crystal glass 26, and the tempered glass 25 are supported by the backplane 1, the structure of the display screen 2 can be simplified, thereby reducing the difficulty of assembling the display screen 2 and increasing the efficiency of assembling the display screen 2.

Specifically, the optical component 27 and the liquid crystal glass 26 are supported by the bearing surface 111 of the backplane body 11 of the backplane 1, and the tempered glass 25 is supported by the support section 13, so that the front frame 22, the middle frame 23 and the tempered glass bead 24 in the existing display screen 2 can be omitted, simplifying the structure of the display screen 2, thereby reducing the difficulty of assembling the display screen 2 and increasing the efficiency of assembling the display screen 2.

In an embodiment, the adhesive part (not shown in the figures) is disposed on a side of the liquid crystal glass 26 close to the optical component 27 along the circumferential direction of the liquid crystal glass 26, and the liquid crystal glass 26 is bonded to the optical component 27 by the adhesive part.

Specifically, the liquid crystal glass 26 is bonded to the optical film 273 of the optical component 27 by the adhesive part, so that the liquid crystal glass 26 can be fixed to the optical component 27, and moreover the installing of the liquid crystal glass 26 can be simplified; the adhesive part may be a double-sided tape. It should be noted that, the middle portion of the liquid crystal glass 26 has a touchable area, and under a condition that the liquid crystal glass 26 is bonded to the optical component 27 by the adhesive part, the adhesive part needs to be disposed outside the touchable area to ensure the normal operation of the liquid crystal glass 26.

In an embodiment, as shown in FIG. 7, the limiting block 16 is disposed on the backplane 1, and two adjacent sides of the limiting block 16 abut against the bearing surface 111 and the connection section 12, respectively; the limiting block 16 abuts against the liquid crystal glass 26 to prevent the liquid crystal glass 26 from sliding out.

Specifically, the limiting block 16 abuts against the liquid crystal glass 26, so that the liquid crystal glass 26 can be limited to prevent the liquid crystal glass 26 from sliding out, that is, the liquid crystal glass 26 is prevented from sliding out of the optical film 273 of the optical component 27, and the optical film 273 is prevented from being damaged by pulling. In this embodiment, two adjacent sides of the limiting block 16 abut against the bearing surface 111 and the connection section 12, respectively; specifically, two adjacent sides of the limiting block 16 abut against the bearing surface 111 and the limit surface 1211, respectively; the bearing surface 111 is perpendicular to the limiting surface 1211, and then the side of the limiting block 16 abutting against the liquid crystal glass 26 is perpendicular to the liquid crystal glass 26, so that the liquid crystal glass 26 can be prevented from sliding out of the optical film 273 of the optical component 27 along the side of the limiting block 16 abutting against the liquid crystal glass 26, thereby preventing the optical film 273 from being damaged by pulling.

In an embodiment, as shown in FIG. 6, the frame 21 has the clamping section 214 located at a side of the support section 13, and two opposite sides of the tempered glass 25 abut against the clamping section 214 and the support section 13, respectively.

Specifically, the tempered glass 25 is clamped between the clamping section 214 of the frame 21 and the support section 13, so that the tempered glass 25 can be prevented from wobbling during operation. In this embodiment, two opposite sides of the tempered glass 25 are bonded to the clamping section 214 and the support section 13, respectively; specifically, two opposite sides of the tempered glass 25 may be bonded to the clamping section 214 and the support section 13 by the double-sided tape, respectively.

In this embodiment, the limiting groove for limiting the tempered glass 25 and the backplane 1 is disposed in the frame 21, and in order to ensure the normal operation of the display screen 2, there is a requirement for the corresponding distance between the parts. As shown in FIG. 7, the distance between the touchable area of the liquid crystal glass 26 and the connection section 12 is set to be A, the width of the support section 13 for supporting the tempered glass 25 is set to be B, the distance between the bent section 15 and the sidewall of the limiting groove is set to be C, the distance between the side of the tempered glass 25 and the sidewall of the limiting groove is set to be D, and the width of the clamping section 214 for pressing the tempered glass 25 (it should be noted that, the display screen 2 in this embodiment has the function of human-computer interaction, and a part of the frame 21 and the infrared filter strip 213 jointly press the tempered glass 25 on a side thereof away from the support section 13) is set to be E.

Specifically, in order to ensure that the touchable area of the liquid crystal glass 26 is not blocked when the display screen 2 is assembled, the distance between the parts should satisfy: E+D<A+B+C. The tempered glass 25 with different material thicknesses requires different widths B of the support section 13 for supporting the tempered glass 25, and the width B may be selected based on actual needs. In order to prevent the tempered glass 25 from sliding out, the width of the clamping section 214 for pressing the tempered glass 25 needs to satisfy: E>5 mm, and under a condition that the width of the clamping section 214 for pressing the tempered glass 25 satisfies the above requirement, the taping operation of the assembler can be convenient.

In summary, the backplane 1 and the display screen 2 including the backplane 1 according to this embodiment have at least the following beneficial technical effects.

The backplane 1 supports the optical component 27 and the liquid crystal glass 26 by the bearing surface 111 of the backplane body 11 while supporting the tempered glass 25 by the support section 13, so that the front frame 22, the middle frame 23 and the tempered glass bead 24 in the existing display screen 2 can be omitted, simplifying the structure of the display screen 2, thereby reducing the difficulty of assembling the display screen 2 and increasing the efficiency of assembling the display screen 2.

The technical features of the embodiments can be combined in any way, and in order to make the description clear, not all the possible combinations of the technical features in the above embodiments are described. However, as long as there is no contradiction in the combinations of these technical features, they should be considered as the scope recited in the present application.

The above embodiments represent only a few implementations of the invention, and description thereof is relatively specific and detailed, but is not to be understood as limiting the patent scope of the present application. It should be noted that a person skilled in the art could also make some changes and modifications without departing from the inventive concept, and these fall within the protection scope of the invention. Therefore, the protection scope of the utility model should be subject to the appended claims.

1. A backplane applicable to a display screen, the display screen comprising tempered glass, liquid crystal glass, and an optical component, the liquid crystal glass and the optical component being stacked, and the tempered glass being disposed at a side of the liquid crystal glass away from the optical component,
wherein the backplane comprises a backplane body, a connection section, and a support section connected in sequence;
the backplane body is disposed on a side of the optical component away from the tempered glass, and a bearing surface is provided on a side of the backplane body close to the optical component;
the connection section is disposed on a side of the backplane body close to the tempered glass, the connection section and the backplane body form an accommodation cavity, the liquid crystal glass and the optical component are both disposed in the accommodation cavity, and the bearing surface is configured to support the optical component and the liquid crystal glass; and
the support section is configured to support the tempered glass.

2. The backplane according to claim 1, wherein
a limiting surface perpendicular to the bearing surface is provided on a side of the connection section close to the backplane body; and
the limiting surface abuts against the liquid crystal glass to prevent the liquid crystal glass from sliding out of the accommodation cavity along the limiting surface.

3. The backplane according to claim 2, wherein
the connection section comprises a first segment and a second segment connected in sequence, the backplane body is connected to a side of the first segment away from the second segment, the support section is connected to a side of the second segment away from the first segment, and the limiting surface is disposed on a side of the first segment close to the accommodation cavity; and
the second segment inclines from a side close to the first segment to a side close to the support section along a direction away from the accommodation cavity.

4. The backplane according to claim 1, wherein a positioning column is provided on the bearing surface and is inserted through a positioning hole in the optical component.

5. The backplane according to claim 1, wherein the backplane further comprises an installation section that is disposed at a side of the support section away from the connection section and is configured to be connected to a frame of the display screen.

6. The backplane according to claim 5, wherein a positioning plate is provided on a side of the installation section away from the support section and is configured to be inserted into a positioning groove of the frame of the display screen.

7. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 1, the backplane being disposed on a side of the optical component away from the tempered glass and being connected to the frame, the optical component being disposed on the bearing surface, and the tempered glass abutting against the support section.

8. The display screen according to claim 7, wherein
an adhesive part is provided on a side of the liquid crystal glass close to the optical component along a circumferential direction of the liquid crystal glass, and
the liquid crystal glass is bonded to the optical component by the adhesive part.

9. The display screen according to claim 7, wherein
a limiting block is provided on the backplane, and two adjacent sides of the limiting block abut against the bearing surface and the connection section, respectively; and
the limiting block abuts against the liquid crystal glass to prevent the liquid crystal glass from sliding out.

10. The display screen according to claim 7, wherein
the frame is provided with a clamping section located at a side of the support section, and
two opposite sides of the tempered glass abut against the clamping section and the support section, respectively.

11. The backplane according to claim 2, wherein the backplane further comprises an installation section that is disposed at a side of the support section away from the connection section and is configured to be connected to a frame of the display screen.

12. The backplane according to claim 3, wherein the backplane further comprises an installation section that is disposed at a side of the support section away from the connection section and is configured to be connected to a frame of the display screen.

13. The backplane according to claim 4, wherein the backplane further comprises an installation section that is disposed at a side of the support section away from the connection section and is configured to be connected to a frame of the display screen.

14. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 2, the backplane being disposed on a side of the optical component away from the tempered glass and being connected to the frame, the optical component being disposed on the bearing surface, and the tempered glass abutting against the support section.

15. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 3, the backplane being disposed on a side of the optical component away from the tempered glass and being connected to the frame, the optical component being disposed on the bearing surface, and the tempered glass abutting against the support section.

16. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 4, the backplane being disposed on a side of the optical component away from the tempered glass and being connected to the frame, the optical component being disposed on the bearing surface, and the tempered glass abutting against the support section.

17. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 5, the backplane being disposed on a side of the optical component away from the tempered glass and being connected to the frame, the optical component being disposed on the bearing surface, and the tempered glass abutting against the support section.

18. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 6, the backplane being disposed on a side of the optical component away from the tempered glass and being connected to the frame, the optical component being disposed on the bearing surface, and the tempered glass abutting against the support section.

19. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 11, the backplane being disposed on a side of the optical component away from the tempered glass and being connected to the frame, the optical component being disposed on the bearing surface, and the tempered glass abutting against the support section.

20. A display screen comprising:
a frame;
tempered glass, liquid crystal glass, and an optical component that are disposed in the frame, the liquid crystal glass and the optical component being stacked, and the tempered glass being disposed at a side of the liquid crystal glass away from the optical component; and
the backplane according to claim 12, the backplane being disposed on a side of the optical component away from the tempered glass and being connected to the frame, the optical component being disposed on the bearing surface, and the tempered glass abutting against the support section.
